(19) United States
(12) Patent Application Publication
(10) Pub. No.: US 2024/0106519 A1
(43) Pub. Date: Mar. 28, 2024

(54) BEAM-LEVEL SELECTION BASED AT LEAST IN PART ON A THROUGHPUT REQUIREMENT

(71) Applicant: QUALCOMM Incorporated, San Diego, CA (US)

(72) Inventors: Jun ZHU, San Diego, CA (US); Mihir Vijay LAGHATE, San Diego, CA (US); Raghu Narayan CHALLA, San Diego, CA (US); Brian Clarke BANISTER, San Diego, CA (US)

(21) Appl. No.: 17/935,798

(22) Filed: Sep. 27, 2022

(51) Int. Cl. H04B 7/08

(52) U.S. Cl. CPC H04B 7/088

(57) ABSTRACT

Various aspects of the present disclosure generally relate to wireless communication. In some aspects, a user equipment (UE) may estimate a throughput requirement associated with a communication between the UE and a network node. The UE may select a beam level, of multiple candidate beam levels capable of satisfying the throughput requirement, that is associated with a lowest power consumption. The UE may communicate with the network node using the beam level. Numerous other aspects are described.

### FIELD OF THE DISCLOSURE

Aspects of the present disclosure generally relate to wireless communication and to techniques and apparatuses for beam-level selection based at least in part on a throughput requirement.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include estimating a throughput requirement associated with a communication between the UE and a network node. The method may include selecting a beam level, of multiple candidate beam levels capable of satisfying the throughput requirement, that is associated with a lowest power consumption. The method may include communicating with the network node using the beam level.

Some aspects described herein relate to a method of wireless communication performed by a UE. The method may include estimating a throughput requirement associated with a communication between the UE and a network node. The method may include generating a set of candidate beams that includes, at each of multiple beam levels, a corresponding candidate beam associated with a best beam metric that is based at least in part on a power hysteresis parameter. The method may include selecting a candidate beam, of the set of candidate beams, to be used for the communication based at least in part on the throughput requirement and a time hysteresis parameter. The method may include communicating with the network node using the candidate beam.

Some aspects described herein relate to a UE for wireless communication. The UE may include a memory and one or more processors coupled to the memory. The one or more processors may be configured to estimate a throughput requirement associated with a communication between the UE and a network node. The one or more processors may be configured to select a beam level, of multiple candidate beam levels capable of satisfying the throughput requirement, that is associated with a lowest power consumption. The one or more processors may be configured to communicate with the network node using the beam level.

Some aspects described herein relate to a UE for wireless communication. The UE may include a memory and one or more processors coupled to the memory. The one or more processors may be configured to estimate a throughput requirement associated with a communication between the UE and a network node. The one or more processors may be configured to generate a set of candidate beams that includes, at each of multiple beam levels, a corresponding candidate beam associated with a best beam metric that is based at least in part on a power hysteresis parameter. The one or more processors may be configured to select a candidate beam, of the set of candidate beams, to be used for the communication based at least in part on the throughput requirement and a time hysteresis parameter. The one or more processors may be configured to communicate with the network node using the candidate beam.

Some aspects described herein relate to a non-transitory computer-readable medium that stores a set of instructions for wireless communication by a UE. The set of instructions, when executed by one or more processors of the UE, may cause the UE to estimate a throughput requirement associated with a communication between the UE and a network node. The set of instructions, when executed by one or more processors of the UE, may cause the UE to select a beam level, of multiple candidate beam levels capable of satisfying the throughput requirement, that is associated with a lowest power consumption. The set of instructions, when executed by one or more processors of the UE, may cause the UE to communicate with the network node using the beam level.

Some aspects described herein relate to a non-transitory computer-readable medium that stores a set of instructions for wireless communication by a UE. The set of instructions, when executed by one or more processors of the UE, may cause the UE to estimate a throughput requirement associated with a communication between the UE and a network node. The set of instructions, when executed by one or more processors of the UE, may cause the UE to generate a set of candidate beams that includes, at each of multiple beam levels, a corresponding candidate beam associated with a best beam metric that is based at least in part on a power hysteresis parameter. The set of instructions, when executed by one or more processors of the UE, may cause the UE to select a candidate beam, of the set of candidate beams, to be used for the communication based at least in part on the throughput requirement and a time hysteresis parameter. The set of instructions, when executed by one or more processors of the UE, may cause the UE to communicate with the network node using the candidate beam.

Some aspects described herein relate to an apparatus for wireless communication. The apparatus may include means for estimating a throughput requirement associated with a communication between the apparatus and a network node. The apparatus may include means for selecting a beam level, of multiple candidate beam levels capable of satisfying the throughput requirement, that is associated with a lowest power consumption. The apparatus may include means for communicating with the network node using the beam level.

Some aspects described herein relate to an apparatus for wireless communication. The apparatus may include means for estimating a throughput requirement associated with a communication between the apparatus and a network node. The apparatus may include means for generating a set of candidate beams that includes, at each of multiple beam levels, a corresponding candidate beam associated with a best beam metric that is based at least in part on a power hysteresis parameter. The apparatus may include means for selecting a candidate beam, of the set of candidate beams, to be used for the communication based at least in part on the throughput requirement and a time hysteresis parameter. The apparatus may include means for communicating with the network node using the candidate beam.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information reference signal beam management procedures, in accordance with the present disclosure.

FIG. 5 is a diagram of an example associated with beam-level selection based at least in part on a throughput requirement, in accordance with the present disclosure.

FIG. 6 is a diagram of another example associated with beam-level selection based at least in part on a throughput requirement, in accordance with the present disclosure.

FIG. 7 is a diagram illustrating an example process performed, for example, by a UE, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

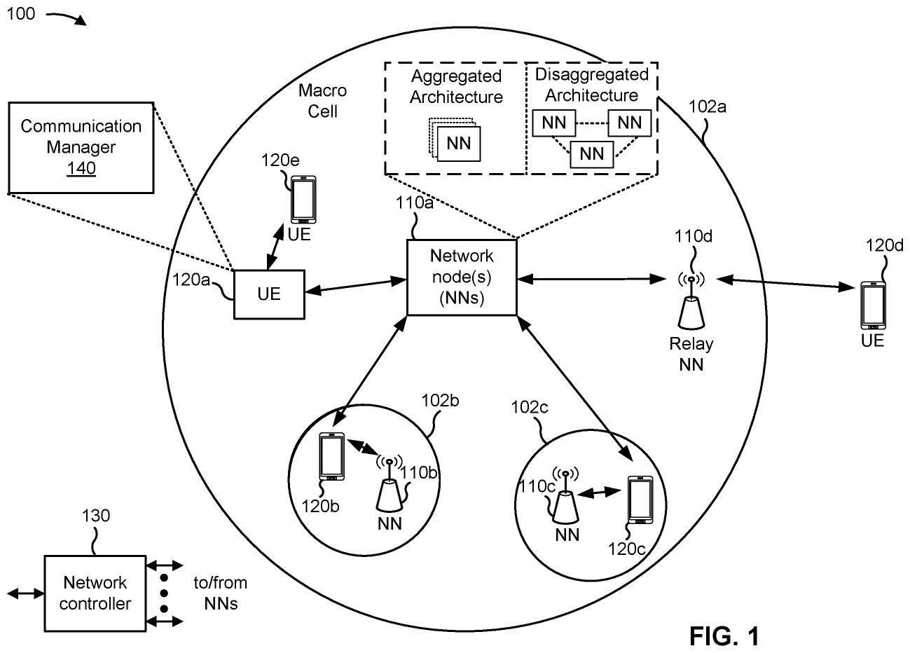

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may estimate a throughput requirement associated with a communication between the UE and a network node 110; select a beam level, of multiple candidate beam levels capable of satisfying the throughput requirement, that is associated with a lowest power consumption; and communicate with the network node 110 using the beam level. In some other aspects, the communication manager 140 may estimate a throughput requirement associated with a communication between the UE 120 and a network node 110; generate a set of candidate beams that includes, at each of multiple beam levels, a corresponding candidate beam associated with a best beam metric that is based at least in part on a power hysteresis parameter; select a candidate beam, of the set of candidate beams, to be used for the communication based at least in part on the throughput requirement and a time hysteresis parameter; and communicate with the network node 110 using the candidate beam. Additionally, or alternatively, the communication manager 140 may perform one or more other operations described herein.

As indicated above, FIG. 1 is provided as an example. Other examples may differ from what is described with regard to FIG. 1.

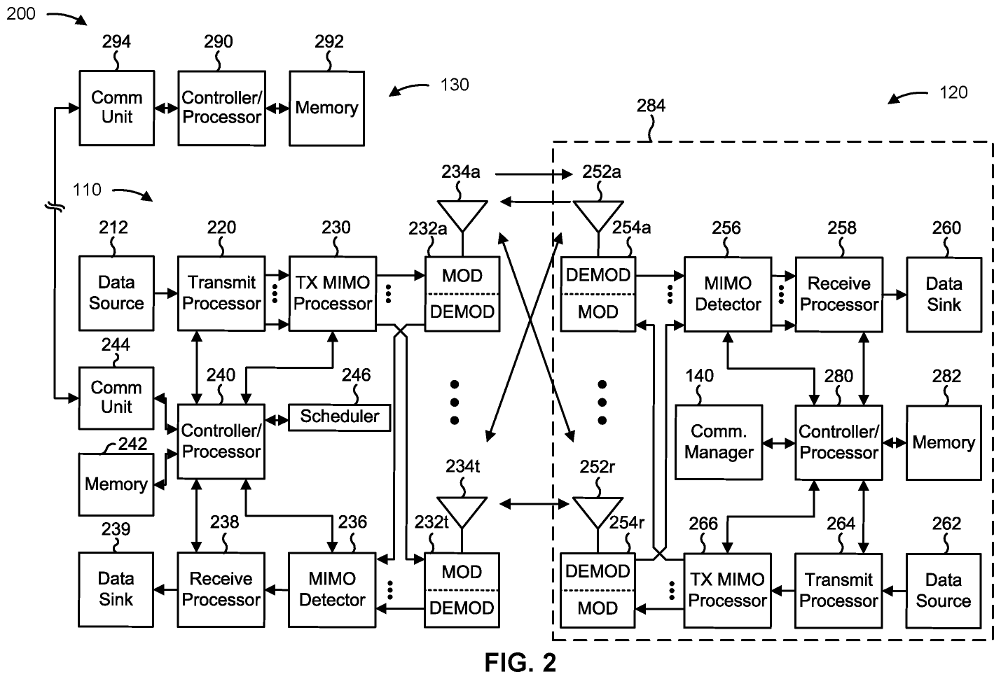

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

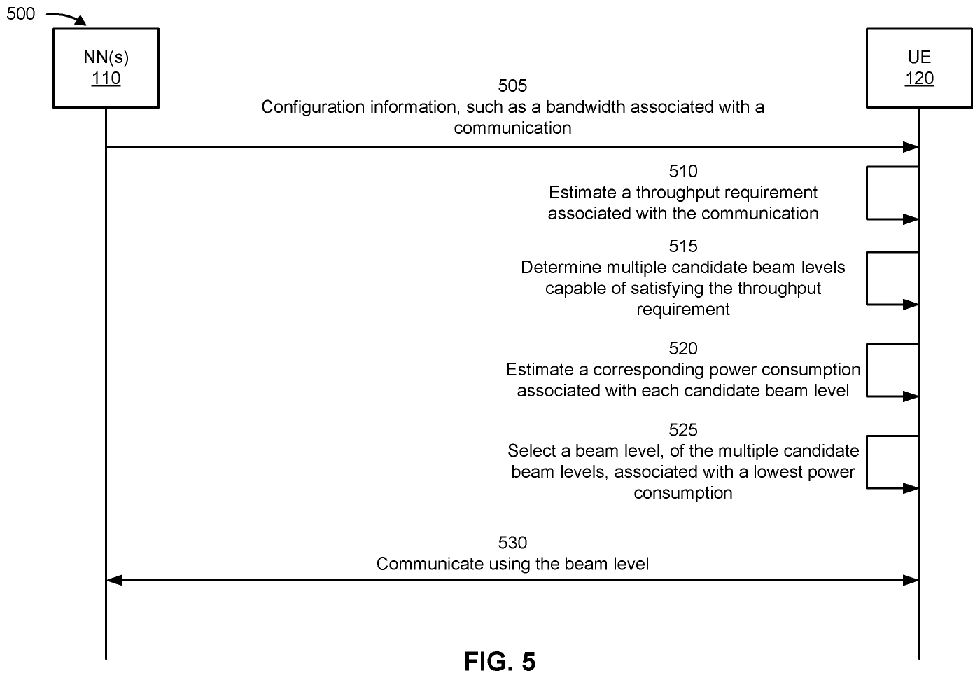

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

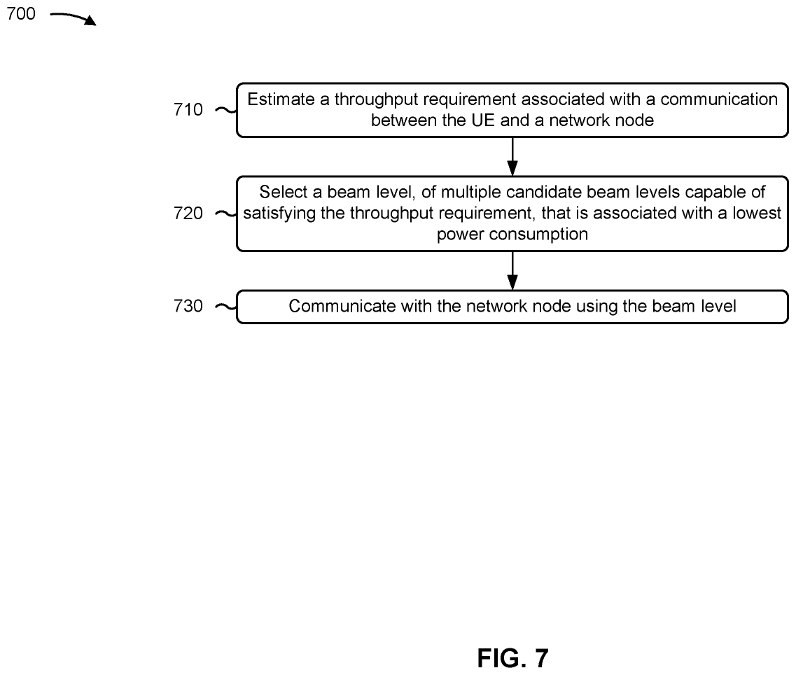

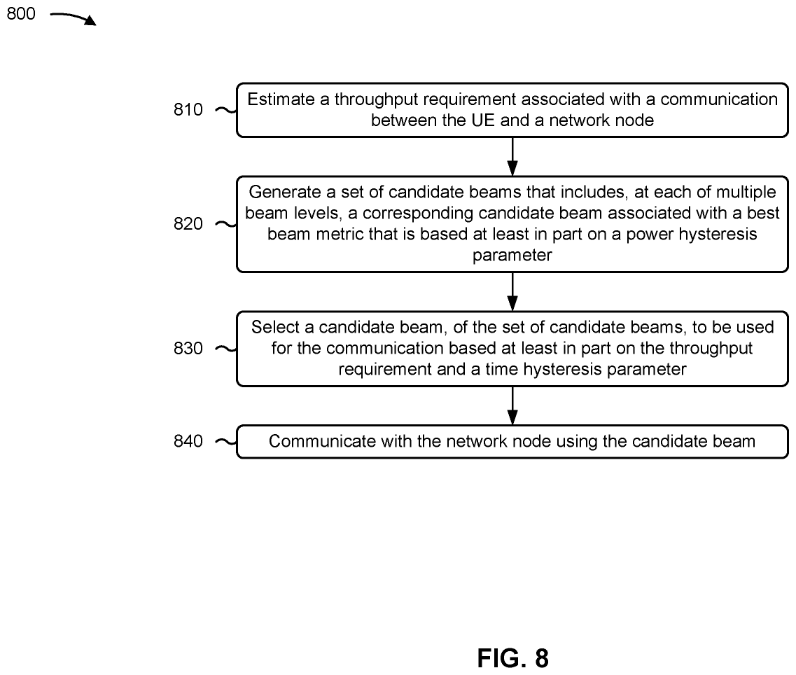

The controller/processor 240 of the network node 110, the controller/processor 280 of the UE 120, and/or any other component(s) of FIG. 2 may perform one or more techniques associated with beam-level selection based at least in part on a throughput requirement, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for estimating a throughput requirement associated with a communication between the UE 120 and a network node 110; means for selecting a beam level, of multiple candidate beam levels capable of satisfying the throughput requirement, that is associated with a lowest power consumption; and/or means for communicating with the network node 110 using the beam level. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for estimating a throughput requirement associated with a communication between the UE 120 and a network node 110; means for generating a set of candidate beams that includes, at each of multiple beam levels, a corresponding candidate beam associated with a best beam metric that is based at least in part on a power hysteresis parameter; means for selecting a candidate beam, of the set of candidate beams, to be used for the communication based at least in part on the throughput requirement and a time hysteresis parameter; and/or means for communicating with the network node 110 using the candidate beam. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

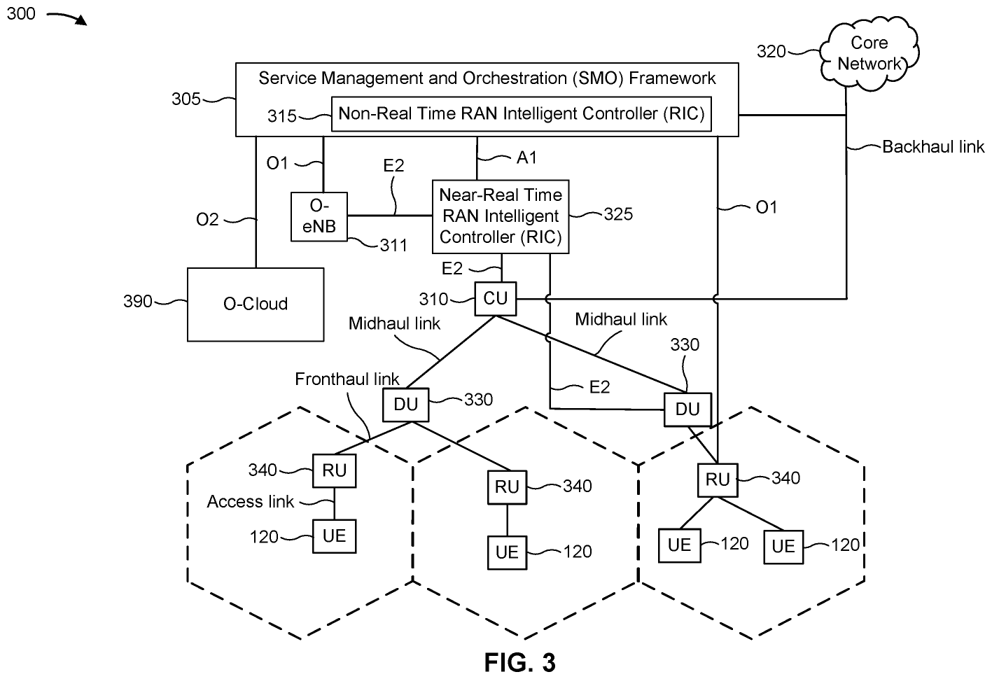

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT MC 325 via an E2 link, or a Non-RT MC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

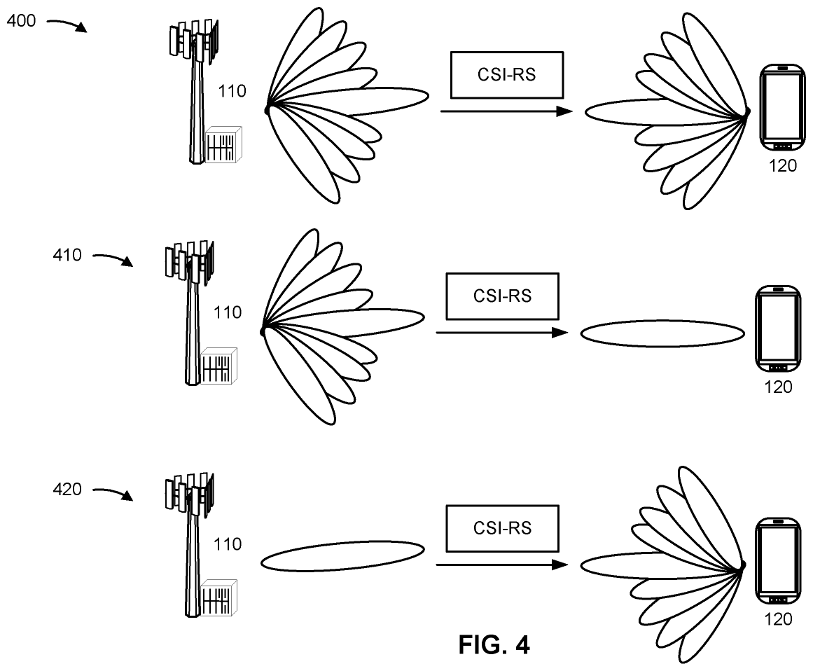

FIG. 4 is a diagram illustrating examples 400, 410, and 420 of channel state information (CSI) reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some cases, beamforming may be useful in millimeter wave (mmW) bands or similar high-frequency bands, because such bands may suffer from high propagation loss that may be countered by the use of narrow beams at the UE 120 and/or at the network node 110. In such aspects, the UE 120 may choose a reception and/or transmission beam in order to optimize reception of the network node 110's signal at the UE 120 during downlink and/or to optimize reception of the UE 120's signal at the network node 110 during uplink. In some examples, the UE 120 may choose a beam level (corresponding to a number of antenna elements, n, used to generate a reception or transmission beam) based at least in part on a performance requirement, such as a throughput requirement associated with communications between the UE 120 and the network node 110. In some cases, throughput may be proportional to a number of antenna elements used (e.g., n). Thus, in some cases, the UE 120 may select a candidate beam associated with a maximum number of antenna elements (e.g., a maximum n) in order to achieve a maximum possible beamforming gain. However, the UE 120's power consumption and thermal cost may also be proportional to the number of antenna elements used. Thus, by selecting the maximum number of antenna elements (e.g., by selecting the highest beam level available), the UE 120 may experience high power consumption and thermal cost.

Moreover, in some cases, the UE 120 may need to switch between beams in order to maintain high-speed communication and smooth uplink and/or downlink communications. Accordingly, the UE 120 may measure one or more metrics, such as RSRP, a signal-to-noise ratio (SNR), or a similar metric, in order to determine a best beam (e.g., a beam associated with a best metric) to be used for communications with the network node 110. In order to avoid frequent switching between beams, sometimes referred to as ping-pong beam switching, the UE 120 may apply account for hysteresis when evaluating whether to switch to a new beam, such as by performing beam switching based at least in part on a power hysteresis parameter. By applying such a power hysteresis parameter, however, the UE 120 may not select a lower beam level and/or a beam associated with a lower power level (even if the lower beam level and/or the beam associated with a lower power level is capable of meeting performance requirements) because the measured metric (e.g., RSRP, SNR, or the like) may be worse than the metric associated with the current beam and/or beam level and thus cannot satisfy the power hysteresis requirement. As a result, the UE 120 may continue to use a higher-level beam and/or higher-power-consuming beam even when a lower-level beam and/or lower-power-consuming beam would meet performance requirements. Always using a higher-level beam and/or higher-power-consuming beam leads to unnecessary power consumption and high thermal cost.

Some techniques and apparatuses described herein enable UE selection of a beam associated with a lower power consumption and/or associated with a measured metric that could not otherwise satisfy a power hysteresis parameter in order to reduce power consumption while maintaining certain performance requirements, such as a throughput requirement. For example, in some aspects, a UE (e.g., UE 120) may estimate a throughput requirement associated with a communication between the UE and a network node (e.g., network node 110) and may select a beam level capable of satisfying the throughput requirement. In some aspects, the UE may select a beam level that is associated with a lowest power consumption out of multiple candidate beam levels capable of satisfying the throughput requirement. Additionally, or alternatively, the UE may select a beam level that is capable of satisfying the throughput requirement based at least in part on a time hysteresis parameter, and not a power hysteresis parameter, such that the UE may switch to a beam associated with a worse measured metric (e.g., a lower RSRP, SNR, or a similar metric) in order to reduce power consumption. As a result, a UE 120 may reduce power consumption and thermal cost and otherwise operate with more efficient usage of power, computing, and network resources.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

FIG. 5 is a diagram of an example 500 associated with beam-level selection based at least in part on a throughput requirement, in accordance with the present disclosure. As shown in FIG. 5, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 5. For example, the UE 120 and the network node 110 may have established a wireless connection via one or more of the beamforming management procedures described above in connection with FIG. 4.

As shown by reference number 505, the network node 110 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may include an indication of a bandwidth associated with a communication between the UE 120 and the network node 110 (e.g., an uplink communication and/or a downlink communication). For example, the network node 110 may transmit, and the UE 120 may receive, an RRC configuration message indicating the bandwidth, and/or the network node 110 may transmit, and the UE 120 may receive, a MAC-CE message activating the bandwidth. The configuration information may indicate additional information associated with the communication between the network node 110 and the UE 120. The UE 120 may configure itself based at least in part on the configuration information. In some aspects, the UE 120 may be configured to perform one or more operations described herein based at least in part on the configuration information.

As shown by reference number 510, the UE 120 may estimate a throughput requirement associated with the communication between the UE 120 and the network node 110 (e.g., the uplink communication and/or the downlink communication). In some aspects, estimating the throughput requirement may be based at least in part on an indication from an upper layer associated with the UE 120. In some other aspects, such as when no throughput requirement is obtained from the upper layer, the UE 120 may estimate the throughput requirement based at least in part on an amount of data to be transmitted via the communication, based at least in part on a historical throughput requirement between the UE 120 and the network node 110, or otherwise. For example, for an uplink transmission, the UE 120 may estimate the throughput requirement based at least in part on a size of a data buffer associated with the uplink transmission. And for a downlink communication, the UE 120 may estimate the throughput requirement based at least in part on an average throughput associated with a number of downlink communications, such an average downlink throughput over a period of time.

As shown by reference number 515, the UE 120 may determine multiple candidate beam levels capable of satisfying the throughput requirement. As described above, a beam level corresponds to a number of antenna elements (e.g., n) used to generate a corresponding beam. Thus, different beam levels are associated with a different number of antenna elements used to generate a corresponding beam. In some aspects, the UE 120 may determine the multiple candidate beam levels based at least in part on a corresponding spectral efficiency (SPEFF) requirement associated with each of the multiple candidate beam levels, based at least in part on the bandwidth associated with the communication (which, as described above in connection with reference number 505, may be indicated to the UE 120 by the network node 110 via an RRC configuration message, or a similar message), and/or based at least in part on a corresponding estimation of a duty cycle of the network node 110 associated with each of the multiple candidate beam levels.

More particularly, in some aspects, the UE 120 may map the throughput requirement to a SPEFF requirement. More particularly, in some aspects, the throughput requirement may be equal to a duty cycle of the network node multiplied by the bandwidth and further multiplied by a SPEFF parameter (e.g., throughput=duty cycle×bandwidth (e.g., in Hz)×SPEFF). Using the SPEFF requirement needed to achieve the throughput requirement, the UE 120 may determine the multiple candidate beam levels capable of satisfying the threshold requirement by selecting candidate beam levels associated with SPEFF parameters greater than or equal to the SPEFF requirement (e.g., by selecting candidate beam levels that are associated with a SPEFF parameter that, when multiplied by the duty cycle and the bandwidth, is greater than or equal to the throughput requirement, as described in more detail below in connection with reference number 525).

In some aspects, the UE 120 may estimate the duty cycle associated with each beam level. For example, the corresponding estimation of the duty cycle of the network node 110 associated with each of the multiple candidate beam levels may be based at least in part on a corresponding past duty cycle of the network node 110 associated with each of the multiple candidate beam levels. Put another way, if a certain duty cycle is regularly used by the network node 110 for a certain beam level, the UE 120 may determine that it is likely that the duty cycle will be used in the upcoming grant if there is no beam level change, and thus may estimate the duty cycle based at least in part on this past duty cycle.

As shown by reference number 520, the UE 120 may estimate a corresponding power consumption associated with each of the multiple candidate beam levels. In some aspects, the UE 120 may estimate the corresponding power consumption associated with each of the multiple candidate beam levels based at least in part on an estimated consumed power associated with a corresponding candidate beam level (which, in some aspects, may be based at least in part on a consumed power lookup table, as described in more detail below) and an estimated duty cycle associated with the corresponding beam level (e.g., the power consumption may be equal to a consumed power parameter associated with n antenna elements multiplied by a duty cycle associated with the n antenna elements).

In some aspects, estimating the consumed power is based at least in part on a consumed power lookup table. More particularly, a UE 120 may be configured, preconfigured, hard-coded, or otherwise provided with a consumed power lookup table, which may associate one or more power consumption parameters with a beam level, a number of antenna elements (e.g., n), and/or a frequency band, among other parameters. In some aspects, using a higher beam level (e.g., using more antenna elements) may result in a reduced power consumption by the UE 120 as compared to using a lower beam level (e.g., using less antenna elements). This may be because when a UE 120 selects a lower beam level (e.g., a beam associated with a relatively low amount of antenna elements), the network node 110 may increase a duty cycle in order to achieve a target data rate, or the like, which may ultimately lead to higher power consumption. Thus, selecting a beam level associated with the lowest power consumption may not always result in the UE 120 selecting the least amount of antenna elements capable of meeting the throughput requirement.

For example, in some aspects the UE 120 may be capable of communicating using one of three different beam levels, sometimes referred to as L1, L2, and L3, with L1 corresponding to a beam associated with a smallest number of antenna elements and L3 corresponding to a beam associated with a largest number of antenna elements. In such aspects, under some conditions, L1 may be associated with a lowest power consumption, while under other conditions L2 may be associated with a lowest power consumption, and while under still other conditions L3 may be associated with a lowest power consumption. More particularly, in the downlink, L3 may result in the lowest power consumption for communications associated with relatively low SNRs (e.g., SNRs less than approximately 2.5), L2 may result in the lowest power consumption for communications associated mid-range SNRs (e.g., SNRs greater than approximately 2.5 and less than approximately 17), and L1 may result in the lowest power consumption for communications associated with relatively high SNRs (e.g., SNRs greater than approximately 17). In the uplink, L2 may result in the lowest power consumption for communications associated with relatively low SNRs (e.g., SNRs less than approximately 2.5), and L1 may result in the lowest power consumption for communications associated with mid-range SNRs and relatively high SNRs (e.g., SNRs greater than approximately 2.5).

As shown by reference number 525, the UE 120 may select a beam level, of the multiple candidate beam levels capable of satisfying the throughput requirement, based at least in part on the beam level being associated with a lowest power consumption. In this way, the UE 120 may conserve power resources and thermal cost as compared to examples in which a UE 120 always selects a beam capable of satisfying a throughput or other performance requirement that is associated with a minimum or maximum number of antenna elements, or the like. More particularly, in some aspects, the UE 120 may select a beam level that is associated with a minimum product (sometimes referred to as argmin n) of an estimated consumed power associated with the beam level (e.g., a consumed power on n antenna elements) and an estimated duty cycle associated with the beam level (e.g., an estimated duty cycle for n antenna elements). In some aspects, the UE 120 may select a beam level that is associated with a minimum product (e.g., argmin n) of an estimated consumed power associated with the beam level and an estimated duty cycle associated with the beam level subject to the beam level being capable of supporting a performance requirement, such as the throughput requirement. Put another way, the UE 120 may select the beam level associated with the lowest power consumption (e.g., associated with a minimum consumed power on n antenna elements multiplied by an estimated duty cycle for n antenna elements) for which a product of a SPEFF parameter associated with the beam level, an estimated duty cycle associated with the beam level, and a bandwidth associated with the communication is greater than or equal to the throughput requirement (e.g., for which SPEFF on n antenna elements×estimated duty cycle for n antenna elements×bandwidth (e.g., in Hz) the throughput requirement).

As shown by reference number 530, the UE 120 may communicate with the network node 110 using the selected beam level, which, as described above, may be associated with a lowest power consumption while still being capable of satisfying the throughput requirement or similar performance requirement. In this way, based at least in part on the UE 120 selecting a beam level, of multiple candidate beam levels capable of satisfying the throughput requirement, that is associated with a lowest power consumption, the UE 120 and/or the network node 110 may conserve computing, power, network, and/or communication resources that may have otherwise been consumed using other candidate beam levels, such as by always using a beam level associated with a minimum or maximum number of antenna elements. For example, based at least in part on the UE 120 selecting a beam level, of multiple candidate beam levels capable of satisfying the throughput requirement, that is associated with a lowest power consumption, the UE 120 and the network node 110 may communicate with a reduced power consumption and/or reduced thermal cost, while still meeting uplink and downlink data rate requirements, as described.

As indicated above, FIG. 5 is provided as an example. Other examples may differ from what is described with respect to FIG. 5.

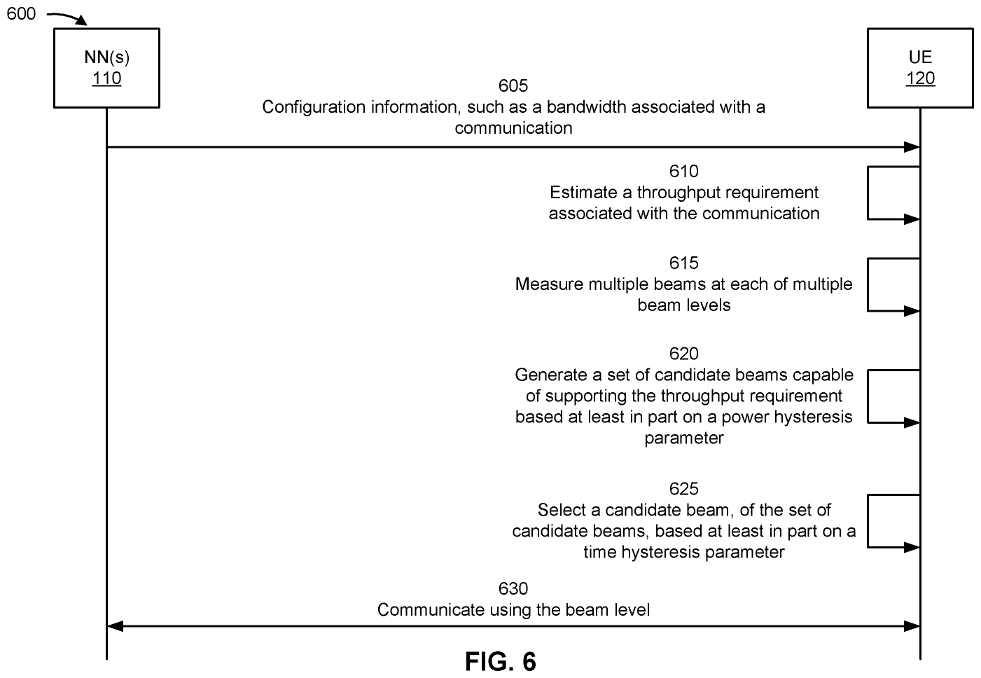

FIG. 6 is a diagram of another example 600 associated with beam-level selection based at least in part on a throughput requirement, in accordance with the present disclosure. As shown in FIG. 6, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 6. For example, the UE 120 and the network node 110 may have established a wireless connection via one or more of the beamforming management procedures described above in connection with FIG. 4.

As shown by reference number 605, the network node 110 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

Similar to the configuration information described above in connection with reference number 505, in some aspects, the configuration information may include an indication of a bandwidth associated with a communication between the UE 120 and the network node 110 (e.g., an uplink communication and/or a downlink communication). For example, the network node 110 may transmit, and the UE 120 may receive, an RRC configuration message indicating the bandwidth, and/or the network node 110 may transmit, and the UE 120 may receive, a MAC-CE message activating the bandwidth. The configuration information may indicate additional information associated with the communication between the network node 110 and the UE 120. The UE 120 may configure itself based at least in part on the configuration information. In some aspects, the UE 120 may be configured to perform one or more operations described herein based at least in part on the configuration information.

As shown by reference number 610, the UE 120 may estimate a throughput requirement associated with a communication between the UE 120 and a network node 110, in a similar manner as described above in connection with reference number 510. More particularly, the UE 120 may estimate the throughput requirement based at least in part on an indication from an upper layer associated with the UE 120. In some other aspects, such as when no throughput requirement is obtained from the upper layer, the UE 120 may estimate the throughput requirement based at least in part on an amount of data to be transmitted via the communication, based at least in part on a historical throughput requirement between the UE 120 and the network node 110, or otherwise. For example, for an uplink transmission, the UE 120 may estimate the throughput requirement based at least in part on a size of a data buffer associated with the uplink transmission. And for a downlink communication, the UE 120 may estimate the throughput requirement based at least in part on an average throughput associated with a number of downlink communications, such an average downlink throughput over a period of time.

As shown by reference number 615, the UE 120 may periodically measure multiple beams (e.g., may periodically measure a power level associated with a reference signal received on the multiple beams) at each of multiple beam levels to determine a corresponding candidate beam associated with a best beam metric. “Best beam metric” may refer to a highest value of any measurable beam metric, such as a highest value of an RSRP metric, an SNR metric, a SPEFF metric, or a similar metric. In this regard, the UE 120 may periodically measure (e.g., measure every 80 milliseconds) multiple beams associated with each of the multiple beam levels (with each beam level being associated with a different number of antenna elements, n, such as levels L1, L2, and L3 described above in connection with FIG. 5), and may select and/or maintain the best beam on each beam level based at least in part on the measured metric (e.g., the UE 120 may select and/or maintain a beam on each beam level based at least in part on the beam being associated with a best (e.g., highest) measured metric out of all of the beams on that beam level).

In some aspects, selecting the best beam at each beam level may be based at least in part on a power hysteresis parameter. A power hysteresis parameter may be associated with a threshold amount (sometimes referred to as P, which, in some aspects, may be in decibels (dB)), such that a measured metric of a candidate beam must be greater than a corresponding measured metric of a current best beam by the threshold amount (e.g., P) in order for the UE 120 to select the candidate beam as the best beam for the beam level. This may avoid ping-pong switching between beams at a given beam level. For example, a UE 120 may maintain a best beam associated with a given beam level, and may periodically measure other beams associated with the given beam level to ensure that the best beam does not become stale. If, during the periodic measurements, another beam becomes better than the best beam by a threshold amount (e.g., if the other beam satisfies the power hysteresis parameter), the UE 120 may select the other beam as the best beam for the given beam level. Additionally, or alternatively, in some aspects, the UE 120 may select the best beam at each beam level based at least in part on one or more filtering techniques.

As shown by reference number 620, the UE 120 may generate a set of candidate beams that includes, at each of multiple beam levels, a corresponding candidate beam associated with a best beam metric that is based at least in part on a power hysteresis parameter. Put another way, the UE 120 may generate a set of candidate beams that includes the best beam from each beam level, as determined by the periodic beam measurements and/or based at least in part on the power hysteresis parameter, as described above in connection with reference number 615.

As shown by reference number 625, the UE 120 may select a candidate beam, of the set of candidate beams, to be used for a communication between the UE 120 and the network node 110 (e.g., an uplink or downlink communication) based at least in part on the throughput requirement and a time hysteresis parameter. As described above in connection with FIGS. 4 and 5, in some aspects, selecting a beam based at least in part on a throughput requirement may result in switching from a beam associated with a better measured metric (e.g., a higher RSRP metric) to a beam associated with a worse measured metric (e.g., a lower RSRP metric), such as to conserve power resources, or the like. Accordingly, using a power hysteresis parameter when switching between beam levels may be untenable, because the UE 120 would never switch to a beam level associated with a worse measured metric and thereby could not realize power-saving benefits or other benefits described above. Nonetheless, without employing any hysteresis parameter, the UE 120 may continually switch between beams (e.g., may experience ping-pong switching) as measured power metrics or the like change over time.

Accordingly, in some aspects, switching between beam levels is based at least in part on a time hysteresis parameter. A time hysteresis parameter may be associated with a threshold time period (sometimes referred to as T) such that a metric of a candidate beam level must be greater than a corresponding metric of a current beam level for a threshold amount of time (e.g., T) in order for the UE 120 to select the candidate beam level as the current beam level. This may avoid ping-pong switching between beam levels. For example, a UE 120 may switch to another beam level (e.g., use the best beam associated with the other beam level) if the other beam level is able to satisfy a performance requirement (e.g., a throughput requirement) for a threshold amount of time (e.g., T).

In some aspects, a UE 120 may select the candidate beam based at least in part on the candidate beam being associated with a lowest beam level capable of supporting the throughput requirement for the threshold amount of time. Put another way, the UE 120 may select a lowest available beam level (e.g., a beam level associated with a lowest number of antenna elements, n) as long as the beam level can support the throughput requirement, which, in some aspects, may reduce power consumption and/or thermal cost.

In some aspects, selecting the beam level (e.g., selecting the candidate beam, of the set of candidate beams) may be based at least in part on whether one or multiple beam levels are capable of supporting the throughput requirement. For example, the set of candidate beams may include two beams (e.g., “Beam A” and “Beam B”), with Beam B being associated with a lower beam level than Beam A. If Beam A is the current serving beam, the UE 120 may measure Beam A and Beam B for T rounds (corresponding to the time hysteresis parameter) to see if Beam A and/or Beam B can satisfy the throughput requirement. In aspects in which both Beam A and Beam B can satisfy the throughput requirement during each of the T rounds, the UE 120 may switch from Beam A to Beam B based at least in part on Beam B being associated with the lower beam level (e.g., in order to reduce power consumption and/or thermal cost).

However, in aspects in which none of the set of candidate beams is capable of supporting the throughput requirement (e.g., in which neither Beam A nor Beam B can satisfy the throughput requirement during each of the T rounds), the UE 120 may select the candidate beam based at least in part on the candidate beam being associated with a highest beam metric. Put another way, when none of the candidate beam levels satisfy the throughout requirement, the UE 120 may select whichever beam is associated with a highest RSRP, a highest SNR, a highest SPEFF, or a similar measured metric.

Moreover, in aspects in which one of the beams (e.g., Beam A) does not satisfy the throughput requirement during the T rounds but the other beam (e.g., Beam B) does, the UE 120 may select the beam capable of supporting the throughput requirement. Put another way, in some aspects, the UE 120 may select the candidate beam based at least in part on the candidate beam being capable of supporting the throughput requirement and no other candidate beams, of the set of candidate beams, being capable of supporting the throughput requirement.

In some aspects, a time period associated with the time hysteresis parameter (e.g., T) may be based at least in part on a number of candidate beams, of the set of candidate beams, that are capable of supporting the throughput requirement. For example, when more or less than one candidate beam, of the set of candidate beams, is capable of supporting the throughput requirement, a first time period may be associated with the time hysteresis parameter, and when only one candidate beam, of the set of candidate beams, is capable of supporting the throughput requirement, a second time period shorter than the first time period may be associated with the time hysteresis parameter. This may be because when only one candidate beam is capable of supporting the throughput requirement, it may be more critical to quickly switch to that beam in order to ensure that a certain data rate is met, and thus a lower T may be used to support quicker beam selection. However, in aspects where no beams are capable of meeting the throughput requirement or in situations when each of the multiple beams is capable of supporting the throughput requirement, switching beams may not significantly impact data rates but may instead be useful to reduce power consumption or the like, and thus a higher T may be used to avoid ping-pong switching between candidate beams.

As shown by reference number 630, the UE 120 may communicate with the network node 110 using the selected candidate beam, which, as described above, may be associated with a lowest beam capable of satisfying the throughput requirement, or a beam associated with a best measured metric when no beam levels are capable of satisfying the throughput requirement. In this way, based at least in part on the UE 120 selecting a candidate beam, of a set of candidate beams, based at least in part on the throughput requirement and a time hysteresis parameter, the UE 120 and/or the network node 110 may conserve computing, power, network, and/or communication resources that may have otherwise been consumed using other candidate beams and/or beam levels, such as by always using a beam level associated with a maximum number of antenna elements. For example, based at least in part on the UE 120 selecting a candidate beam, of a set of candidate beams, based at least in part on the throughput requirement and a time hysteresis parameter, the UE 120 and the network node 110 may communicate with a reduced power consumption and/or reduced thermal cost while avoiding frequent, or ping-pong, switching between candidate beams, as described.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with beam-level selection based at least in part on a throughput requirement.

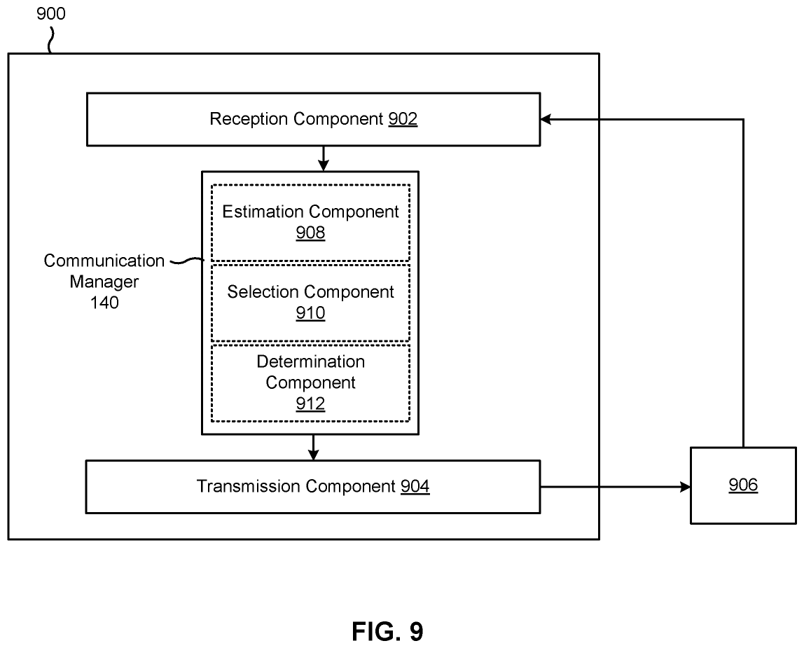

As shown in FIG. 7, in some aspects, process 700 may include estimating a throughput requirement associated with a communication between the UE and a network node (block 710). For example, the UE (e.g., using communication manager 140 and/or estimation component 908, depicted in FIG. 9) may estimate a throughput requirement associated with a communication between the UE and a network node, as described above.

As further shown in FIG. 7, in some aspects, process 700 may include selecting a beam level, of multiple candidate beam levels capable of satisfying the throughput requirement, that is associated with a lowest power consumption (block 720). For example, the UE (e.g., using communication manager 140 and/or selection component 910, depicted in FIG. 9) may select a beam level, of multiple candidate beam levels capable of satisfying the throughput requirement, that is associated with a lowest power consumption, as described above.

As further shown in FIG. 7, in some aspects, process 700 may include communicating with the network node using the beam level (block 730). For example, the UE (e.g., using communication manager 140, reception component 902, and/or transmission component 904, depicted in FIG. 9) may communicate with the network node using the beam level, as described above.

Process 700 may include additional aspects, such as any single aspect or any combination of aspects described below and/or in connection with one or more other processes described elsewhere herein.

In a first aspect, estimating the throughput requirement is based at least in part on a size of a data buffer associated with an uplink transmission.

In a second aspect, alone or in combination with the first aspect, estimating the throughput requirement is based at least in part on an indication from an upper layer associated with the UE.

In a third aspect, alone or in combination with one or more of the first and second aspects, estimating the throughput requirement is based at least in part on an average throughput associated with a number of downlink communications.

In a fourth aspect, alone or in combination with one or more of the first through third aspects, process 700 includes determining the multiple candidate beam levels.

In a fifth aspect, alone or in combination with one or more of the first through fourth aspects, determining the multiple candidate beam levels is based at least in part on a corresponding spectral efficiency requirement associated with each of the multiple candidate beam levels.

In a sixth aspect, alone or in combination with one or more of the first through fifth aspects, determining the multiple candidate beam levels is based at least in part on a bandwidth associated with the communication.

In a seventh aspect, alone or in combination with one or more of the first through sixth aspects, the one or more processors are further configured to receive, from the network node, an indication of the bandwidth.

In an eighth aspect, alone or in combination with one or more of the first through seventh aspects, determining the multiple candidate beam levels is based at least in part on a corresponding estimation of a duty cycle of the network node associated with each of the multiple candidate beam levels.

In a ninth aspect, alone or in combination with one or more of the first through eighth aspects, the corresponding estimation of the duty cycle of the network node associated with each of the multiple candidate beam levels is based at least in part on a corresponding past duty cycle of the network node associated with each of the multiple candidate beam levels.

In a tenth aspect, alone or in combination with one or more of the first through ninth aspects, process 700 includes estimating a corresponding power consumption associated with each of the multiple candidate beam levels.

In an eleventh aspect, alone or in combination with one or more of the first through tenth aspects, process 700 includes selecting the beam level based at least in part on the beam level being associated with a minimum product, out of multiple products associated with the multiple candidate beam levels, of an estimated consumed power associated with a corresponding candidate beam level and an estimated duty cycle associated with the corresponding beam level, and a product of a spectral efficiency parameter associated with the beam level, an estimated duty cycle associated with the beam level, and a bandwidth associated with the communication that is greater than or equal to the throughput requirement.

In a twelfth aspect, alone or in combination with one or more of the first through eleventh aspects, the estimated consumed power is based at least in part on a consumed power lookup table.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with beam-level selection based at least in part on a throughput requirement.

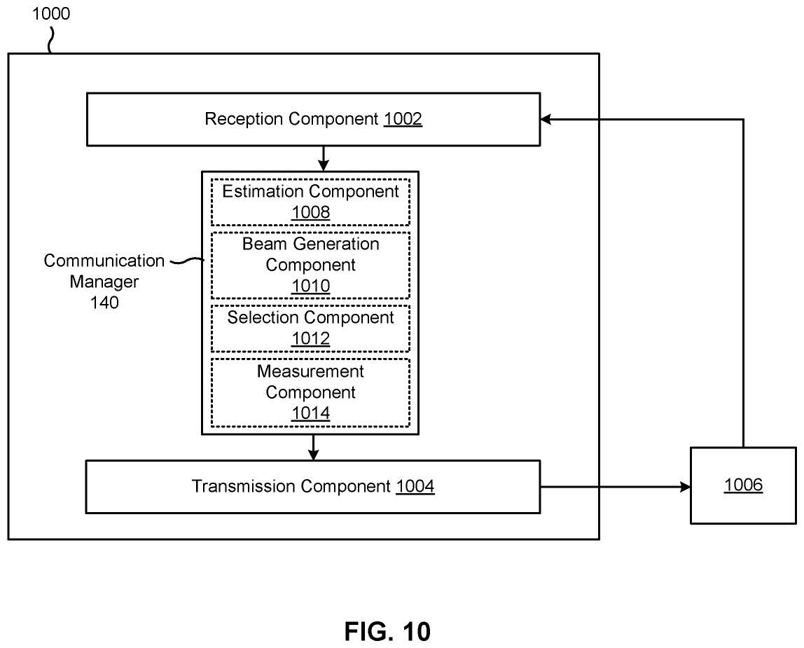

As shown in FIG. 8, in some aspects, process 800 may include estimating a throughput requirement associated with a communication between the UE and a network node (block 810). For example, the UE (e.g., using communication manager 140 and/or estimation component 1008, depicted in FIG. 10) may estimate a throughput requirement associated with a communication between the UE and a network node, as described above.

As further shown in FIG. 8, in some aspects, process 800 may include generating a set of candidate beams that includes, at each of multiple beam levels, a corresponding candidate beam associated with a best beam metric that is based at least in part on a power hysteresis parameter (block 820). For example, the UE (e.g., using communication manager 140 and/or beam generation component 1010, depicted in FIG. 10) may generate a set of candidate beams that includes, at each of multiple beam levels, a corresponding candidate beam associated with a best beam metric that is based at least in part on a power hysteresis parameter, as described above.

As further shown in FIG. 8, in some aspects, process 800 may include selecting a candidate beam, of the set of candidate beams, to be used for the communication based at least in part on the throughput requirement and a time hysteresis parameter (block 830). For example, the UE (e.g., using communication manager 140 and/or selection component 1012, depicted in FIG. 10) may select a candidate beam, of the set of candidate beams, to be used for the communication based at least in part on the throughput requirement and a time hysteresis parameter, as described above.

As further shown in FIG. 8, in some aspects, process 800 may include communicating with the network node using the candidate beam (block 840). For example, the UE (e.g., using communication manager 140, reception component 1002, and/or transmission component 1004, depicted in FIG. 10) may communicate with the network node using the candidate beam, as described above.

Process 800 may include additional aspects, such as any single aspect or any combination of aspects described below and/or in connection with one or more other processes described elsewhere herein.

In a first aspect, the best beam metric is one of a reference signal received power metric, a signal-to-noise ratio metric, or a spectral efficiency metric.

In a second aspect, alone or in combination with the first aspect, process 800 includes periodically measuring multiple beams at each of the multiple beam levels to determine the corresponding candidate beam associated with the best beam metric.

In a third aspect, alone or in combination with one or more of the first and second aspects, selecting the candidate beam is based at least in part on the candidate beam being associated with a lowest beam level capable of supporting the throughput requirement.

In a fourth aspect, alone or in combination with one or more of the first through third aspects, none of the set of candidate beams is capable of supporting the throughput requirement, and selecting the candidate beam is based at least in part on the candidate beam being associated with a highest best beam metric.

In a fifth aspect, alone or in combination with one or more of the first through fourth aspects, selecting the candidate beam is based at least in part on the candidate beam being capable of supporting the throughput requirement and no other candidate beams, of the set of candidate beams, being capable of supporting the throughput requirement.

In a sixth aspect, alone or in combination with one or more of the first through fifth aspects, a time period associated with the time hysteresis parameter is based at least in part on a number of candidate beams, of set of candidate beams, that are capable of supporting the throughput requirement.

In a seventh aspect, alone or in combination with one or more of the first through sixth aspects, when more or less than one candidate beam, of the set of candidate beams, is capable of supporting the throughput requirement, a first time period is associated with the time hysteresis parameter, and when only one candidate beam, of the set of candidate beams, is capable of supporting the throughput requirement, a second time period shorter than the first time period is associated with the time hysteresis parameter.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., UE 120), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE 120, a network node 110, or another wireless communication device) using the reception component 902 and the transmission component 904. As further shown, the apparatus 900 may include the communication manager 140. The communication manager 140 may include one or more of an estimation component 908, a selection component 910, or a determination component 912, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The estimation component 908 may estimate a throughput requirement associated with a communication between the UE and a network node (e.g., network node 110). The selection component 910 may select a beam level, of multiple candidate beam levels capable of satisfying the throughput requirement, that is associated with a lowest power consumption. The reception component 902 and/or the transmission component 904 may communicate with the network node using the beam level.

The determination component 912 may determine the multiple candidate beam levels.

The estimation component 908 may estimate a corresponding power consumption associated with each of the multiple candidate beam levels.

The selection component 910 may select the beam level based at least in part on the beam level being associated with a minimum product, out of multiple products associated with the multiple candidate beam levels, of an estimated consumed power associated with a corresponding candidate beam level and an estimated duty cycle associated with the corresponding beam level, and a product of a spectral efficiency parameter associated with the beam level, an estimated duty cycle associated with the beam level, and a bandwidth associated with the communication that is greater than or equal to the throughput requirement.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE 120, a network node 110, or another wireless communication device) using the reception component 1002 and the transmission component 1004. As further shown, the apparatus 1000 may include the communication manager 140. The communication manager 140 may include one or more of an estimation component 1008, a beam generation component 1010, a selection component 1012, or a measurement component 1014, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The estimation component 1008 may estimate a throughput requirement associated with a communication between the UE and a network node (e.g., network node 110). The beam generation component 1010 may generate a set of candidate beams that includes, at each of multiple beam levels, a corresponding candidate beam associated with a best beam metric that is based at least in part on a power hysteresis parameter. The selection component 1012 may select a candidate beam, of the set of candidate beams, to be used for the communication based at least in part on the throughput requirement and a time hysteresis parameter. The reception component 1002 and/or the transmission component 1004 may communicate with the network node using the candidate beam.

The measurement component 1014 may periodically measure multiple beams at each of the multiple beam levels to determine the corresponding candidate beam associated with the best beam metric.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: estimating a throughput requirement associated with a communication between the UE and a network node; selecting a beam level, of multiple candidate beam levels capable of satisfying the throughput requirement, that is associated with a lowest power consumption; and communicating with the network node using the beam level.

Aspect 2: The method of Aspect 1, wherein estimating the throughput requirement is based at least in part on a size of a data buffer associated with an uplink transmission.

Aspect 3: The method of any of Aspects 1-2, wherein estimating the throughput requirement is based at least in part on an indication from an upper layer associated with the UE.

Aspect 4: The method of any of Aspects 1-3, wherein estimating the throughput requirement is based at least in part on an average throughput associated with a number of downlink communications.

Aspect 5: The method of any of Aspects 1-4, further comprising determining the multiple candidate beam levels.

Aspect 6: The method of Aspect 5, wherein determining the multiple candidate beam levels is based at least in part on a corresponding spectral efficiency requirement associated with each of the multiple candidate beam levels.

Aspect 7: The method of any of Aspects 5-6, wherein determining the multiple candidate beam levels is based at least in part on a bandwidth associated with the communication.

Aspect 8: The method of Aspect 7, further comprising receiving, from the network node, an indication of the bandwidth.

Aspect 9: The method of any of Aspects 5-8, wherein determining the multiple candidate beam levels is based at least in part on a corresponding estimation of a duty cycle of the network node associated with each of the multiple candidate beam levels.

Aspect 10: The method of Aspect 9, wherein the corresponding estimation of the duty cycle of the network node associated with each of the multiple candidate beam levels is based at least in part on a corresponding past duty cycle of the network node associated with each of the multiple candidate beam levels.

Aspect 11: The method of any of Aspects 1-10, further comprising estimating a corresponding power consumption associated with each of the multiple candidate beam levels.

Aspect 12: The method of any of Aspects 1-11, further comprising selecting the beam level based at least in part on the beam level being associated with: a minimum product, out of multiple products associated with the multiple candidate beam levels, of an estimated consumed power associated with a corresponding candidate beam level and an estimated duty cycle associated with the corresponding beam level, and a product of a spectral efficiency parameter associated with the beam level, an estimated duty cycle associated with the beam level, and a bandwidth associated with the communication that is greater than or equal to the throughput requirement.

Aspect 13: The method of Aspect 12, wherein the estimated consumed power is based at least in part on a consumed power lookup table.

Aspect 14: A method of wireless communication performed by a UE, comprising: estimating a throughput requirement associated with a communication between the UE and a network node; generating a set of candidate beams that includes, at each of multiple beam levels, a corresponding candidate beam associated with a best beam metric that is based at least in part on a power hysteresis parameter; selecting a candidate beam, of the set of candidate beams, to be used for the communication based at least in part on the throughput requirement and a time hysteresis parameter; and communicating with the network node using the candidate beam.

Aspect 15: The method of Aspect 14, wherein the best beam metric is one of a reference signal received power metric, a signal-to-noise ratio metric, or a spectral efficiency metric.

Aspect 16: The method of any of Aspects 14-15, further comprising periodically measuring multiple beams at each of the multiple beam levels to determine the corresponding candidate beam associated with the best beam metric.

Aspect 17: The method of any of Aspects 14-16, wherein selecting the candidate beam is based at least in part on the candidate beam being associated with a lowest beam level capable of supporting the throughput requirement.

Aspect 18: The method of any of Aspects 14-17, wherein none of the set of candidate beams is capable of supporting the throughput requirement, and wherein selecting the candidate beam is based at least in part on the candidate beam being associated with a highest best beam metric.

Aspect 19: The method of any of Aspects 14-18, wherein selecting the candidate beam is based at least in part on the candidate beam being capable of supporting the throughput requirement and no other candidate beams, of the set of candidate beams, being capable of supporting the throughput requirement.

Aspect 20: The method of any of Aspects 14-19, wherein a time period associated with the time hysteresis parameter is based at least in part on a number of candidate beams, of set of candidate beams, that are capable of supporting the throughput requirement.

Aspect 21: The method of Aspect 20, wherein, when more or less than one candidate beam, of the set of candidate beams, is capable of supporting the throughput requirement, a first time period is associated with the time hysteresis parameter, and wherein, when only one candidate beam, of the set of candidate beams, is capable of supporting the throughput requirement, a second time period shorter than the first time period is associated with the time hysteresis parameter.

Aspect 22: An apparatus for wireless communication at a device, comprising a processor; memory coupled with the processor; and instructions stored in the memory and executable by the processor to cause the apparatus to perform the method of one or more of Aspects 1-13.

Aspect 23: A device for wireless communication, comprising a memory and one or more processors coupled to the memory, the one or more processors configured to perform the method of one or more of Aspects 1-13.

Aspect 24: An apparatus for wireless communication, comprising at least one means for performing the method of one or more of Aspects 1-13.

Aspect 25: A non-transitory computer-readable medium storing code for wireless communication, the code comprising instructions executable by a processor to perform the method of one or more of Aspects 1-13.

Aspect 26: A non-transitory computer-readable medium storing a set of instructions for wireless communication, the set of instructions comprising one or more instructions that, when executed by one or more processors of a device, cause the device to perform the method of one or more of Aspects 1-13.

Aspect 27: An apparatus for wireless communication at a device, comprising a processor; memory coupled with the processor; and instructions stored in the memory and executable by the processor to cause the apparatus to perform the method of one or more of Aspects 14-21.

Aspect 28: A device for wireless communication, comprising a memory and one or more processors coupled to the memory, the one or more processors configured to perform the method of one or more of Aspects 14-21.

Aspect 29: An apparatus for wireless communication, comprising at least one means for performing the method of one or more of Aspects 14-21.

Aspect 30: A non-transitory computer-readable medium storing code for wireless communication, the code comprising instructions executable by a processor to perform the method of one or more of Aspects 14-21.

Aspect 31: A non-transitory computer-readable medium storing a set of instructions for wireless communication, the set of instructions comprising one or more instructions that, when executed by one or more processors of a device, cause the device to perform the method of one or more of Aspects 14-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
estimate a throughput requirement associated with a communication between the UE and a network node;
select a beam level, of multiple candidate beam levels capable of satisfying the throughput requirement, that is associated with a lowest power consumption; and
communicate with the network node using the beam level.

2. The UE of claim 1, wherein estimating the throughput requirement is based at least in part on a size of a data buffer associated with an uplink transmission.

3. The UE of claim 1, wherein estimating the throughput requirement is based at least in part on an indication from an upper layer associated with the UE.

4. The UE of claim 1, wherein estimating the throughput requirement is based at least in part on an average throughput associated with a number of downlink communications.

5. The UE of claim 1, wherein the one or more processors are further configured to determine the multiple candidate beam levels.

6. The UE of claim 5, wherein determining the multiple candidate beam levels is based at least in part on a corresponding spectral efficiency requirement associated with each of the multiple candidate beam levels.

7. The UE of claim 5, wherein determining the multiple candidate beam levels is based at least in part on a bandwidth associated with the communication.

8. The UE of claim 7, wherein the one or more processors are further configured to receive, from the network node, an indication of the bandwidth.

9. The UE of claim 5, wherein determining the multiple candidate beam levels is based at least in part on a corresponding estimation of a duty cycle of the network node associated with each of the multiple candidate beam levels.

10. The UE of claim 9, wherein the corresponding estimation of the duty cycle of the network node associated with each of the multiple candidate beam levels is based at least in part on a corresponding past duty cycle of the network node associated with each of the multiple candidate beam levels.

11. The UE of claim 1, wherein the one or more processors are further configured to estimate a corresponding power consumption associated with each of the multiple candidate beam levels.

12. The UE of claim 1, wherein the one or more processors are further configured to select the beam level based at least in part on the beam level being associated with:
a minimum product, out of multiple products associated with the multiple candidate beam levels, of an estimated consumed power associated with a corresponding candidate beam level and an estimated duty cycle associated with the corresponding beam level, and
a product of a spectral efficiency parameter associated with the beam level, an estimated duty cycle associated with the beam level, and a bandwidth associated with the communication that is greater than or equal to the throughput requirement.

13. The UE of claim 12, wherein the estimated consumed power is based at least in part on a consumed power lookup table.

14. A user equipment (UE) for wireless communication, comprising:
a memory; and
one or more processors, coupled to the memory, configured to:
estimate a throughput requirement associated with a communication between the UE and a network node;
generate a set of candidate beams that includes, at each of multiple beam levels, a corresponding candidate beam associated with a best beam metric that is based at least in part on a power hysteresis parameter;
select a candidate beam, of the set of candidate beams, to be used for the communication based at least in part on the throughput requirement and a time hysteresis parameter; and
communicate with the network node using the candidate beam.

15. The UE of claim 14, wherein the best beam metric is one of a reference signal received power metric, a signal-to-noise ratio metric, or a spectral efficiency metric.

16. The UE of claim 14, wherein the one or more processors are further configured to periodically measure multiple beams at each of the multiple beam levels to determine the corresponding candidate beam associated with the best beam metric.

17. The UE of claim 14, wherein selecting the candidate beam is based at least in part on the candidate beam being associated with a lowest beam level capable of supporting the throughput requirement.

18. The UE of claim 14, wherein none of the set of candidate beams is capable of supporting the throughput requirement, and wherein selecting the candidate beam is based at least in part on the candidate beam being associated with a highest best beam metric.

19. The UE of claim 14, wherein selecting the candidate beam is based at least in part on the candidate beam being capable of supporting the throughput requirement and no other candidate beams, of the set of candidate beams, being capable of supporting the throughput requirement.

20. The UE of claim 14, wherein a time period associated with the time hysteresis parameter is based at least in part on a number of candidate beams, of set of candidate beams, that are capable of supporting the throughput requirement.

21. The UE of claim 20, wherein, when more or less than one candidate beam, of the set of candidate beams, is capable of supporting the throughput requirement, a first time period is associated with the time hysteresis parameter, and wherein, when only one candidate beam, of the set of candidate beams, is capable of supporting the throughput requirement, a second time period shorter than the first time period is associated with the time hysteresis parameter.

22. A method of wireless communication performed by a user equipment (UE), comprising:
estimating a throughput requirement associated with a communication between the UE and a network node;
selecting a beam level, of multiple candidate beam levels capable of satisfying the throughput requirement, that is associated with a lowest power consumption; and
communicating with the network node using the beam level.

23. The method of claim 22, further comprising determining the multiple candidate beam levels.

24. The method of claim 23, wherein determining the multiple candidate beam levels is based at least in part on a corresponding estimation of a duty cycle of the network node associated with each of the multiple candidate beam levels.

25. The method of claim 22, further comprising estimating a corresponding power consumption associated with each of the multiple candidate beam levels.

26. The method of claim 22, further comprising selecting the beam level based at least in part on the beam level being associated with:
a minimum product, out of multiple products associated with the multiple candidate beam levels, of an estimated consumed power associated with a corresponding candidate beam level and an estimated duty cycle associated with the corresponding beam level, and
a product of a spectral efficiency parameter associated with the beam level, an estimated duty cycle associated with the beam level, and a bandwidth associated with the communication that is greater than or equal to the throughput requirement.

27. A method of wireless communication performed by a user equipment (UE), comprising:
estimating a throughput requirement associated with a communication between the UE and a network node;
generating a set of candidate beams that includes, at each of multiple beam levels, a corresponding candidate beam associated with a best beam metric that is based at least in part on a power hysteresis parameter;
selecting a candidate beam, of the set of candidate beams, to be used for the communication based at least in part on the throughput requirement and a time hysteresis parameter; and
communicating with the network node using the candidate beam.

28. The method of claim 27, wherein selecting the candidate beam is based at least in part on the candidate beam being associated with a lowest beam level capable of supporting the throughput requirement.

29. The method of claim 27, wherein none of the set of candidate beams is capable of supporting the throughput requirement, and wherein selecting the candidate beam is based at least in part on the candidate beam being associated with a highest best beam metric.

30. The method of claim 27, wherein selecting the candidate beam is based at least in part on the candidate beam being capable of supporting the throughput requirement and no other candidate beams, of the set of candidate beams, being capable of supporting the throughput requirement.
